(19) United States
(12) Patent Application Publication
(10) Pub. No.: US 2024/0209869 A1
(43) Pub. Date: Jun. 27, 2024

(54) ELECTRIC FAN AND CLEANING APPARATUS

(71) Applicant: GUANGDONG WELLING MOTOR MANUFACTURING CO., LTD., Foshan, (CN)

(72) Inventor: Rong DING, Foshan (CN)

(73) Assignee: GUANGDONG WELLING MOTOR MANUFACTURING CO., LTD., Foshan (CN)

(21) Appl. No.: 18/595,052

(22) Filed: Mar. 4, 2024

Related U.S. Application Data
(63) Continuation of application No. PCT/CN2022/079373, filed on Mar. 4, 2022.

(30) Foreign Application Priority Data
Sep. 26, 2021 (CN) 202111040388.4
Sep. 26, 2021 (CN) 202122146261.2

(51) Int. Cl. F04D 29/44; A47L 5/22; F04D 25/06

(52) U.S. Cl. CPC F04D 29/444; A47L 5/22; F04D 25/06

(57) ABSTRACT

An electric fan and a cleaning apparatus are provided. The electric fan includes a fan cover, a movable impeller, a casing assembly, a fixed impeller and an electric motor. The movable impeller is arranged in the fan cover and forms an air intake channel with the fan cover. The movable impeller includes a movable impeller body and air intake blades. The movable impeller body has a maximum outer edge diameter of D1. The casing assembly includes an outer cylinder and a supporting structure. The outer cylinder has an outer diameter of D2. The fixed impeller is connected to the supporting structure. A first diffuser channel is formed between the fixed impeller and the outer cylinder. The fixed impeller incudes a supporting base and a first diffuser blade. The supporting base has an outer diameter of D3. D2 is (1.2-1.6) time of D1. D2 is (1.15-1.6) of D3.

### CROSS-REFERENCE TO RELATED APPLICATIONS

This application is a continuation of International Application No. PCT/CN2022/079373 filed on Mar. 4, 2022, which claims priority to and benefits of Chinese Patent Application No. 202111040388.4 filed on Sep. 6, 2021 and Chinese Patent Application No. 202122146261.2 filed on Sep. 6, 2021, the entire contents of each of which are incorporated herein by reference for all purposes. No new matter has been introduced.

### FIELD

The present disclosure relates to the field of electric fans, and in particular to an electric fan and a cleaning apparatus.

### BACKGROUND

With the development of vacuum cleaners and other related household cleaning apparatus, electric fans, as the core power components of the products, are gradually developing in the direction of smaller size, lighter weight and higher power. However, in the related art, when the electric fan satisfies the requirements of small size and light weight, its power will also be affected to a certain extent. Similarly, the size of the electric fan increases accordingly when it meets certain power requirements. Thus, it is also necessary to optimize the structure of the electric fan to solve the above problems.

### SUMMARY

The present disclosure aims at solving at least one of the technical problems existing in the related art. To this end, the present disclosure provides an electric fan that can address the need for a compact design while substantially increasing the maximum power capability of the electric fan.

The present disclosure further provides a cleaning apparatus provided with the above electric fan.

The electric fan according to embodiments of a first aspect of the present disclosure includes: a fan cover; a movable impeller arranged in the fan cover and forming an air intake channel with the fan cover, the movable impeller including a movable impeller body and air intake blades arranged on the outer periphery of the movable impeller body, with the movable impeller body having a maximum outer edge diameter of D1; a casing assembly including an outer cylinder and a supporting structure arranged in the outer cylinder, where the outer cylinder is connected to the fan cover and the outer cylinder has an outer diameter of D2; a fixed impeller connected to the supporting structure and located at an end of the supporting structure adjacent to the movable impeller, with a first diffuser channel being formed between the fixed impeller and the outer cylinder, where the first diffuser channel is in communication with the air intake channel, and the fixed impeller includes a supporting base and first diffuser blades arranged on an outer periphery of the supporting base, with the supporting base having an outer diameter of D3; and an electric motor arranged to drive the movable impeller to rotate, where D2=(1.2-1.6)D1, and D2=(1.15-1.6)D3.

The electric fan according to embodiments of the present disclosure has at least the following beneficial effects: the electric motor drives the movable impeller to rotate, and airflow will be formed and enter the first diffuser channel through the air intake channel to be pressurized and then flow out. By defining the relationship among the outer diameter D2 of the outer cylinder and the maximum outer edge diameter D1 of the movable impeller body and the outer diameter D3 of the supporting base, that is, D2=(1.2-1.6) D1 and D2=(1.15-1.6) D3, the electric fan of this technical scheme can make the sizes of the movable impeller and the supporting base larger given a certain size of the outer diameter of the casing assembly and taking into account the diffusion effect of the electric fan, so as to increase the amount of air intake of the movable impeller and increase the rotating speed of the electric motor, thus greatly increasing the power of the electric fan. Therefore, the electric fan can maximize the power while meeting the requirement of small size. As a result, an electric fan with an outer diameter of 45 mm or less can meet the power requirement of 450 W, thereby realizing the miniaturization and light-weight of the electric fan and greatly increasing the upper limit of power that a small-sized electric fan can achieve.

According to some embodiments of the present disclosure, the supporting structure includes an inner cylinder and a mounting hub arranged in the inner cylinder. A second diffuser channel is formed between the inner cylinder and the outer cylinder. The second diffuser channel is in communication with an air outlet end of the first diffuser channel. Second diffuser blades are arranged between the inner cylinder and the outer cylinder. The fixed impeller is mounted on the mounting hub.

According to some embodiments of the present disclosure, the mounting hub includes a bearing mounting base and a connecting structure. The connecting structure is arranged between the bearing mounting base and the inner cylinder. The bearing mounting base is provided with at least one first sealing step mated with an inner wall of the supporting base for seal.

According to some embodiments of the present disclosure, the connecting structure includes a plurality of connecting ribs distributed at intervals along a circumferential direction of the bearing mounting base. At least two of the connecting ribs are provided with first connecting holes, and the supporting base is provided with at least two second connecting holes. The first connecting holes and the second connecting holes are threaded and fixed by fasteners.

According to some embodiments of the present disclosure, the supporting base is provided with a first mating face extending along an axial direction and a second mating face extending along a radial direction at a sealing position mating with the first sealing step, and the first sealing step is provided with a first wall face and a second wall face which are connected to form an angle, the first wall face abutting against the first mating face, and the second wall face abutting against the second mating face, and the angle being greater than or equal to 90°.

According to some embodiments of the present disclosure, a stator accommodating cavity is formed in the inner cylinder, the electric motor includes a stator assembly, the stator assembly being connected to the casing assembly and at least partially extending into the stator accommodating cavity, and an end of the inner cylinder away from the fixed impeller is provided with a notch groove, the notch groove being in communication with the stator accommodating cavity and the second diffuser channel.

According to some embodiments of the present disclosure, the inner cylinder is provided with a second sealing step mated with an inner peripheral wall of the supporting base for seal.

According to some embodiments of the present disclosure, the supporting base is provided with a transition section at an air intake end of the first diffuser channel, the transition section being configured to guide airflow to flow from the air intake channel to the first diffuser channel.

According to some embodiments of the present disclosure, an outer contour line of the transition section is arc-shaped.

According to some embodiments of the present disclosure, an angle between a straight line formed by connecting two ends of the outer contour line of the transition section and a horizontal line is 30°-65°.

According to some embodiments of the present disclosure, along an axial direction of the movable impeller, a distance between an end of the outer contour line of the transition section adjacent to an air outlet end of the air outlet channel and a maximum outer edge of the movable impeller body is 0.5 mm-1 mm.

According to some embodiments of the present disclosure, the number of the second diffuser blades is greater than the number of the first diffuser blades.

According to some embodiments of the present disclosure, the second diffuser blade includes a first blade structure and a second blade structure. The second blade structure includes a main body portion and a thickened portion in sequence along an airflow direction of the second diffuser channel. The thickened portion is connected to the main body portion at a position of 0.5-0.8 times a chord length of the second blade structure, and an end of the second blade structure away from the inner cylinder defines an outer edge. The thickness of the outer edge of the main body portion gradually increases along the airflow direction at a position that is 0.1-0.3 times the chord length away from the second blade structure, and the thickness of the outer edge of the thickened portion is unchanged along the airflow direction. The first blade structure is arranged between adjacent second blade structures.

According to some embodiments of the present disclosure, a minimum thickness of the outer edge of the second blade structure is 0.1-0.3 times a maximum thickness of the outer edge of the second blade structure.

According to some embodiments of the present disclosure, an end of the casing assembly away from the fan cover is provided with an electric control board, with a maximum distance between the fan cover and the electric control board in an axial direction being H, a maximum input power of the electric fan being P, and a maximum power density of the electric fan being σ, where σ=P/(3.14*(D2/2)²*H), and σ is greater than or equal to 0.0045 W/mm³.

The cleaning apparatus according to embodiments of a second aspect of the present disclosure includes an electric fan as described in the above embodiments.

The cleaning apparatus according to embodiments of the present disclosure has at least the following beneficial effects.

With the electric fan of embodiments of the first aspect, the electric fan drives, by the electric motor, the movable impeller to rotate and to form airflow, which enters the first diffuser channel through the air intake channel to be pressurized and then flows out. By defining the relationship among the outer diameter D2 of the outer cylinder and the maximum outer edge diameter D1 of the movable impeller body and the outer diameter D3 of the supporting base, that is, D2=(1.2-1.6)D1, and D2=(1.15-1.6)D3, the electric fan can make the sizes of the movable impeller and the supporting base larger given a certain size of the outer diameter of the casing assembly and taking into account the diffusion effect of the electric fan, so as to increase the amount of air intake of the movable impeller and increase the rotating speed of the electric motor, thus greatly increasing the power of the electric fan, which ensures that the electric fan can maximize the power while meeting the requirement of small size, so that an electric fan with an outer diameter of 45 mm or less can meet the power requirement of 450 W, thereby greatly increasing the upper limit of power that a small-sized electric fan can achieve, which facilitates the miniaturization and light-weight of the cleaning apparatus.

Additional aspects and advantages of the present disclosure will be given, in part, in the following description, in part as will become apparent from the following description, or as will be learned through the practice of the present disclosure.

### BRIEF DESCRIPTION OF DRAWINGS

The present disclosure will be further explained with reference to the accompanying drawings and embodiments. In the accompanying drawings:

FIG. 1 is a cross-sectional view of an electric fan from a view angle according to an embodiment of the present disclosure;

FIG. 2 is a cross-sectional view of the electric fan from another view angle according to an embodiment of the present disclosure;

FIG. 3 is an exploded schematic diagram of a casing assembly and a fixed impeller according to an embodiment of the present disclosure;

FIG. 4 is a schematic diagram of a movable impeller according to an embodiment of the present disclosure;

FIG. 5 is a schematic diagram of a casing assembly from a view angle according to an embodiment of the present disclosure;

FIG. 6 is a schematic diagram of a casing assembly with an outer cylinder removed according to an embodiment of the present disclosure; and

FIG. 7 is a schematic diagram of a casing assembly from another view angle according to an embodiment of the present disclosure.

### LIST OF REFERENCE NUMERALS

fan cover 100; air intake channel 110; third sealing step 120;

movable impeller 200; movable impeller body 210; air intake blade 220;

fixed impeller 300; first diffuser channel 310; first diffuser blade 330;

supporting base 320; first sealing step 321; first wall face 3211; second wall face 3212; second connecting hole 322; transition section 323;

casing assembly 400; outer cylinder 410; supporting arm 412; first threaded hole 4121; fourth sealing step 411; second diffuser channel 440;

second diffuser blade 450; first blade structure 451; second blade structure 452; arc-shaped face 4521; boss 453; second threaded hole 4531; locating post 4532;

inner cylinder 420; second sealing step 421; stator accommodating cavity 422; notch groove 423; heat dissipation channel 424;

mounting hub 430; bearing mounting base 431; bearing mounting cavity 4311; connecting rib 432; first connecting hole 4321;

stator assembly 500;

rotor assembly 600; rotating shaft 610; bearing 620;

electric control board 700; and first communication hole 710.

### DETAILED DESCRIPTION OF EMBODIMENTS

Embodiments of the present disclosure are described in detail below, and examples of said embodiments are shown in the accompanying drawings, where the same or similar numerals throughout denote the same or similar elements or elements having the same or similar functions. The embodiments described below by referring to the drawings are exemplary, only for explaining the present disclosure, and cannot be understood as limiting the present disclosure.

In the description of the present disclosure, it is to be understood that descriptions involving orientation, such as, the orientation or positional relationship indicated by up, down, or the like, are based on the orientation or positional relationship shown in the accompanying drawings, and are intended solely to facilitate the description of the present disclosure and to simplify the description, and are not indicative of, or suggestive of, that the apparatus or element referred to must have a particular orientation or be constructed and operated with a particular orientation, and therefore are not to be construed as limitations on the present disclosure.

In the description of the present disclosure, “a plurality of” refers to more than two. If “first” and “second”, etc. are referred to, it is only for the purpose of distinguishing technical features, and shall not be construed as indicating or implying relative importance or implying the number of the indicated technical features or implying the sequence of the indicated technical features.

In the description of the present disclosure, unless otherwise explicitly defined, the words such as setting, mounting and connection should be understood in a broad sense, and those skilled in the technical field can reasonably determine the specific meanings of the above words in the present disclosure in combination with the specific contents of the technical scheme.

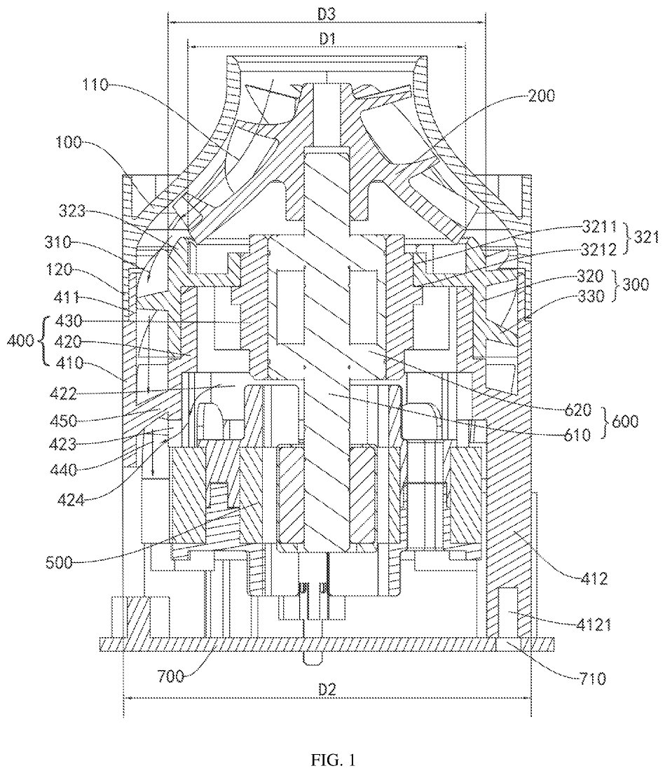

As shown in FIG. 1, the present disclosure provides an electric fan, which can be used in a cleaning apparatus (such as, a vacuum cleaner). As the core functional component of the cleaning apparatus, the performance of the electric fan directly determines the quality of the cleaning apparatus. For portable cleaning apparatus (such as, handheld vacuum cleaners or sweeping robots), they have gradually developed towards light-weight and portability, making the requirements for small size, high power and light weight of electric fans more stringent.

Currently, none of the electric fans on the market with an outer diameter of 45 mm or less can reach a power of 450 W. Based on this, the electric fan in the embodiments of the present disclosure, by optimizing the internal structure, can greatly increase the power of the electric fan while satisfying the requirement for a small size, thereby ensuring that the electric fan with an outer diameter of 45 mm or less can achieve the power of 450 W, and ensuring that the maximum power density σ of the electric fan is not less than 0.0045 W/mm³.

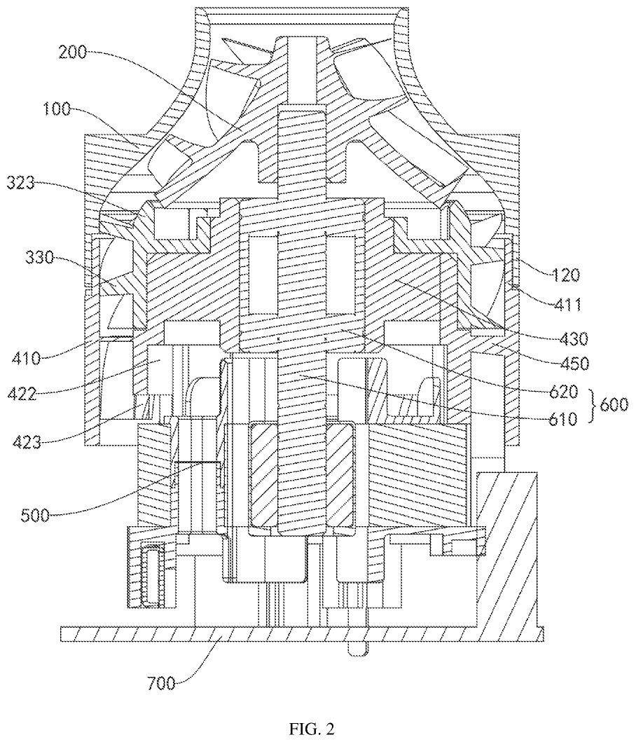

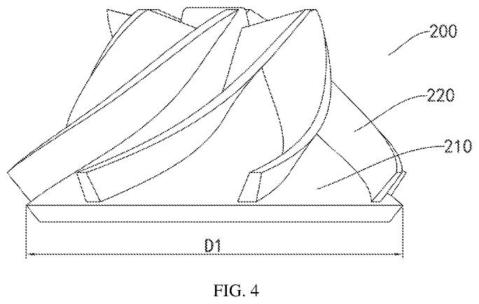

For example, referring to FIGS. 1 and 2, the electric fan provided in embodiments of the present disclosure includes a fan cover 100, a movable impeller 200, a casing assembly 400, a fixed impeller 300, and an electric motor. The movable impeller 200 is mounted in the fan cover 100 and defines an air intake channel 110 with the fan cover 100. The electric motor is configured to drive the movable impeller 200 to rotate to create airflow, and the kinetic energy of the airflow increases as the airflow enters the air intake channel 110. Referring to FIG. 4, the movable impeller 200 includes a movable impeller body 210 and air intake blades 220 arranged on an outer periphery of the movable impeller body 210, where the movable impeller body 210 is provided with mounting slots or mounting holes, and the electric motor is configured to extend into the mounting slots or mounting holes of the movable impeller body 210 for transmission connection with the movable impeller body 210, thereby driving the overall movable impeller 200 to rotate and form airflow. The vacuum cleaner and other cleaning apparatus can then suck the dust, garbage and other foreign matter on the ground or other medium surfaces into the filter bag or other processing structure of the cleaning apparatus under the negative pressure of the electric fan, thus completing the work of sucking in the dust and other foreign matter. Here, the movable impeller body 210 has a maximum outer edge diameter of D1, which means that the maximum distance of the outer contour line of the movable impeller body 210 in the radial direction is D1.

Referring to FIGS. 1 to 3, the casing assembly 400 includes an outer cylinder 410 and a supporting structure (not shown in the figures) provided inside the outer cylinder 410, where the outer cylinder 410 is connected to the fan cover 100, and the outer cylinder 410 has an outer diameter of D2. The fixed impeller 300 and the supporting structure are connected, and the fixed impeller 300 is arranged at an end of the supporting structure adjacent to the movable impeller 200, and the supporting structure serves to support the fixed impeller 300. Between the fixed impeller 300 and the outer cylinder 410, a first diffuser channel 310 is defined, with an air intake end of the first diffuser channel 310 being in communication with an air outlet end of the air intake channel 110, thereby allowing airflow to circulate from the air intake channel 110 into the first diffuser channel 310. After the airflow flows into the first diffuser channel 310 from the air intake channel 110, the first diffuser channel 310 converts the kinetic energy of the airflow into air pressure energy to realize the diffusion effect, which causes the pressure of the airflow to be increased, so that the airflow flowing out of the air outlet end of the first diffuser channel 310 can be blown further, so as to increase the air outlet intensity and air outlet efficiency of the electric fan.

It should be noted that a channel along the axial direction is reserved between the supporting structure and the outer cylinder 410, and the airflow, after flowing out of the first diffuser channel 310, can be blown out through the channel and wind can be formed. It is to be understood that the supporting structure may be arranged in the interior of the outer cylinder 410 by means of nesting, welding, or connection by connectors, or may be integrally molded with the outer cylinder 410, which is not specifically limited herein.

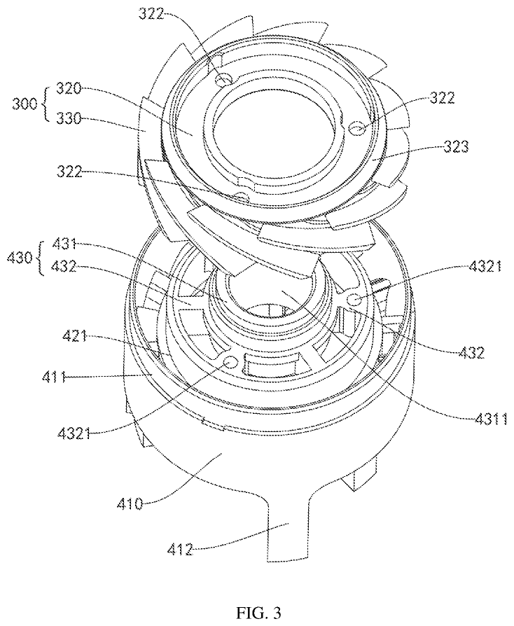

Referring to FIG. 3, the fixed impeller 300 includes a supporting base 320 and first diffuser blades 330, where the first diffuser blades 330 are arranged at intervals over the outer periphery of the supporting base 320, the supporting base 320 having an outer diameter of D3. It can be understood that the supporting base 320 has an inner peripheral wall and an inner wall disposed in the inner peripheral wall. Among them, the inner peripheral wall is cylindrical, and the inner wall is arranged in the cylindrical inner peripheral wall and provided with a through hole at the center. The first diffuser blades 330 are arranged on the wall face of the inner peripheral wall and are arranged at intervals along the circumferential direction of the inner peripheral wall. Here, D2=(1.2-1.6)D1, and D2=(1.15-1.6)D3, so that the sizes of the movable impeller 200 and the supporting base 320 can be made as large as possible given a certain size of the outer diameter D2 of the outer cylinder 410, i.e., the outer diameter of the casing assembly 400, and taking into account the diffusion effect of the electric fan. For example, when the size of the maximum outer edge diameter D1 of the movable impeller body 210 is equal to D2/(1.2-1.6), the overall size of the movable impeller 200 increases accordingly, and the size of the movable impeller 200 is increased in comparison with the existing movable impeller 200 in the electric fan of the same outer diameter standard, thereby increasing the amount of air intake when the movable impeller 200 rotates. When the size of the outer diameter D3 of the supporting base 320 is equal to D2/(1.15-1.6), the inner cavity in the supporting base 320 that is configured to accommodate the electric motor increases accordingly. In comparison with the electric motor accommodating cavity in the existing electric fan of the same outer diameter standard, the size of the inner cavity in the supporting base 320 that is configured to accommodate the electric motor increases, thereby enabling the stator assembly 500 of the electric motor to be made as large as possible, which in turn increases the output power of the electric motor, so that the electric motor can raise up the rotating speed of the movable impeller, thus increasing the amount of air intake per unit of time.

In short, given a certain size of the outer diameter of the electric fan, by defining the relationship among the outer diameter D2 of the outer cylinder 410 and the maximum outer edge diameter D1 of the movable impeller body 210 and the outer diameter D3 of the supporting base 320, it is possible to make the sizes of the movable impeller 200 and the supporting base 320 as large as possible while taking into account the diffusion effect of the electric fan, so as to increase the amount of air intake of the movable impeller 200 and to increase the rotating speed of the movable impeller 200 under the driving by the electric motor, thus greatly increasing the amount of airflow intake of the electric fan. While ensuring that the electric fan meets the requirement of small size, i.e., while keeping the size of the outer diameter of the electric fan unchanged, the power can be maximized, so that the electric fan with an outer diameter of 45 mm or less can meet the power requirement of 450 W, which is conducive to the miniaturization and light-weight of cleaning apparatus, such as, vacuum cleaners.

Referring to FIGS. 1 to 3 and 5, in some embodiments, the supporting structure includes an inner cylinder 420 and a mounting hub 430, where a mounting space is formed in the interior of the inner cylinder 420, and the mounting hub 430 is provided in the interior of the inner cylinder 420, i.e., inside the mounting space. The fixed impeller 300 is provided on the mounting hub 430, and the mounting hub 430 serves to support and fix the fixed impeller 300. Between the inner cylinder 420 and the outer cylinder 410, a second diffuser channel 440 is defined, that is, the reserved channel as previously described is formed, with an air intake end of the second diffuser channel 440 being in communication with the air outlet end of the first diffuser channel 310, so that the airflow can be circulated from the first diffuser channel 310 into the second diffuser channel 440, and then out of the second diffuser channel 440.

Between the inner cylinder 420 and the outer cylinder 410, second diffuser blades 450 are provided, the second diffuser blades 450 being located in the second diffuser channel 440, so that after the airflow flows out of the first diffuser channel 310, it continues to flow and enter the second diffuser channel 440, and the airflow continues to be pressurized under the action of the second diffuser blades 450 to further enhance the air outlet intensity of the airflow. For example, the second diffuser blades 450 may be fixed to an outer wall face of the inner cylinder 420, or to an inner wall face of the outer cylinder 410, or may be fixed between the outer wall face of the inner cylinder 420 and the inner wall face of the outer cylinder 410 at the same time, which is not specifically limited herein.

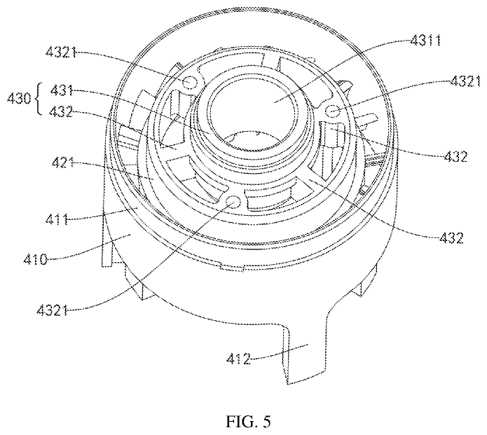

Further, referring to FIG. 5, the mounting hub 430 includes a connecting structure (not shown in the figure) and a bearing mounting base 431, where the connecting structure is provided between the bearing mounting base 431 and the inner cylinder 420, and the connecting structure is used for connection with the fixed impeller 300 so as to fix and support the fixed impeller 300. It can be understood that the connecting structure and the fixed impeller 300 may be fixed by means of threaded connection, snap-fit, or nesting through column bodies and slots, or the like.

Continuing to refer to FIGS. 1, 2, 3, and 5, several first sealing steps 321 are provided on the peripheral wall of the bearing mounting base 431, and the number of the first sealing steps 321 may be set to 1, 2, or more than 2. The bearing mounting base 431 passes through the through holes formed in the inner wall of the supporting base 320 and is sealingly mated with the inner wall of the supporting base 320 by means of the first sealing steps 321, so as to avoid the airflow from flowing out of the air outlet end of the air intake channel 110 and then flowing into the supporting base 320, and thus to reduce the loss of the airflow and ensure the air outlet intensity of the airflow, thereby effectively ensuring the working efficiency of the electric fan. It can be understood that the number of the first sealing steps 321 can be set according to the actual mounting requirements, and when the number of the first sealing steps 321 is set to be multiple, the plurality of first sealing steps 321 are distributed sequentially along the axial direction. Similarly, the mating face of the inner wall of the supporting base 320 is also set accordingly based on the number and shape and size of the first sealing steps 321 in order to realize a sealing mating.

For example, referring to FIGS. 1 to 3, the supporting base 320 is provided with a first mating face and a second mating face at a position mated with the first sealing step 321 for seal, where the first mating face extends in an axial direction and the second mating face extends in a radial direction. The first sealing step 321 is provided with a first wall face 3211 and a second wall face 3212, where the first wall face 3211 and the second wall face 3212 are connected to form an angle, meaning that there is a certain angle between the first wall face 3211 and the second wall face 3212, which is not less than 90°. In other words, the angle between the first wall face 3211 and the second wall face 3212 is greater than or equal to 90° Among them, the first wall face 3211 abuts against the first mating face, then the sealing between the supporting base 320 and the first sealing steps 321 in the axial direction can be achieved; and the second wall face 3212 abuts against the second mating face, then the sealing between the supporting base 320 and the first sealing steps 321 in the radial direction can be achieved.

Here, in this embodiment, “abut against” can be understood to mean that the first wall face 3211 and the first mating face are in contact with each other and at least part of their structures can be fitted to each other and that the second wall face 3212 and the second mating face are in contact with each other and at least part of their structures can be fitted to each other, so as to achieve the effect of sealing in both the axial direction and the radial direction, thereby ensuring the sealing of the supporting base 320 when it is mated with the first sealing steps 321. In addition, the angle formed between the first wall face 3211 and the second wall face 3212 is set to be greater than or equal to 90°, which facilitates demolding and production, and produces better sealing.

Similarly, referring to FIGS. 1, 2, 3 and 5, the inner cylinder 420 is provided with a second sealing step 421, the second sealing step 421 being sealingly mated with the supporting base 320. In other words, the second sealing step 421 is fitted to the inner peripheral wall of the supporting base 320, which avoids the entry of the airflow into the inner cylinder 420 through the portion of mating between the inner cylinder 420 and the second sealing step 421, thereby reducing the leakage of the airflow, and ensuring the stability of the airflow as well as the pressurization effect. By means of the dual provision of the first sealing steps 321 and the second sealing step 421, the effect of avoiding airflow leakage into the inner cylinder 420 can be achieved, thus providing satisfactory sealing. When the airflow flows out of the air outlet end of the second diffuser channel 440, the air pressure of the airflow is more stable and of a higher intensity, which is conducive to improving the working efficiency of the electric fan.

The mounting hub 430, while mating with the supporting base 320 via the first sealing steps 321 on the bearing mounting base 431, is also securely connected to the supporting base 320 via the connecting structure. The connecting structure may take the form of a plurality of ribs being provided around the periphery of the bearing mounting base 431; it may also take the form of a sealing plate being socketed on the outside of the bearing mounting base 431, which means that an annular sealing plate is provided between the bearing mounting base 431 and the inner cylinder 420, with the inner ring of the sealing plate being connected to the bearing mounting base 431, and the outer ring of the sealing plate being connected to the inner cylinder 420; and it may also take the form of a plurality of base bodies and ribs being distributed at intervals at the same time, or the like, which is not specifically limited herein.

Referring to FIGS. 1, 2, 3, and 5, in some embodiments, the connecting structure includes a plurality of connecting ribs 432, where the connecting ribs 432 are distributed at intervals along a circumferential direction around the periphery of the bearing mounting base 431, and the number of the connecting ribs 432 may be set according to the actual needs. For example, the number of the connecting ribs 432 may be set to be 6 to 9, or the like, which is not specifically limited herein. At least two of the connecting ribs 432 are provided with first connecting holes 4321, and the supporting base 320 is provided with second connecting holes 322, the number of the second connecting holes 322 coinciding with the first connecting hole 4321. The first connecting holes 4321 and the second connecting holes 322 are threaded and fixed by fasteners to connect the supporting base 320 with the connecting ribs 432, so as to mount the fixed impeller 300 on the inner cylinder 420, thus realizing the work of fixing the fixed impeller 300 with the casing assembly 400.

In addition, the connecting structure takes the form of a plurality of connecting rib 432 being arranged at intervals, which can reduce the amount of materials used in the production of the product, while connecting the bearing mounting base 431 and the inner cylinder 420, thus reducing the production cost. It can be understood that the numbers of the first connecting holes 4321 and of the second connecting holes 322 can be set to 2 or 3 or the like according to the actual connecting needs, which is not specifically limited herein.

In some embodiments, three connecting ribs 432 distributed equally spaced apart are each provided with a first connecting hole 4321, and the supporting base 320 is provided with three second connecting holes 322 distributed at equal spacing, the first connecting holes 4321 and the second connecting holes 322 being positioned in one-to-one correspondence. Similarly, three fasteners are provided, which, after correspondingly passing through the first connecting holes 4321 and the second connecting holes 322 in sequence, connect the supporting base 320 and the connecting ribs 432, so as to connect the fixed impeller 300 and the casing assembly 400. The casing assembly 400 and the fixed impeller 300 are connected and fixed through three positions, which allows for a stable triangular relationship to be formed, thus making the connection more robust.

Further, the number of the connecting ribs 432 is a multiple of 3, so as to meet the connection requirements between the casing assembly 400 and the fixed impeller 300, and to ensure that the supporting base 320 and the connecting ribs 432 can be connected through three equally spaced positions, thereby meeting the mounting requirements of the fixed impeller 300, and thus improving the ease and stability of the mounting.

It can be understood that a bearing mounting cavity 4311 is formed in the bearing mounting base 431 and that the electric motor includes a stator assembly 500 and a rotor assembly 600, where the stator assembly 500 is mounted on the casing assembly 400 and the stator assembly 500 is located at an end adjacent to the air outlet end of the second diffuser channel 440. The stator assembly 500 is completely staggered or partially staggered from the casing assembly 400 in the radial direction of the outer cylinder 410. The rotor assembly 600 includes a rotating shaft 610 and a bearing 620, the bearing 620 being mounted in the bearing mounting cavity 4311. The first end of the rotating shaft 610 mates with the stator assembly 500, and the second end of the rotating shaft 610 passes through the bearing 620 and is then connected to the movable impeller 200 to drive the movable impeller 200 to rotate and thus form airflow.

That is, after the rotating shaft 610 passes through the bearing 620, the first end of the rotating shaft 610 mates with the stator assembly 500, and the second end of the rotating shaft 610 extends into the movable impeller body 210 so as to be connected to the movable impeller 200. For example, the bearing 620 can serve to support the rotating shaft 610, ensuring that the rotating shaft 610 can rapidly drive the movable impeller 200 to rotate under the action of the stator assembly 500 so as to form airflow to output wind.

In the radial direction of the outer cylinder 410, when the stator assembly 500 is completely staggered from the casing assembly 400, the size of the electric fan increase accordingly. Further, referring to FIGS. 1 and 2, inside the inner cylinder 420, a stator accommodating cavity 422 is formed to accommodate the stator assembly, the stator assembly 500 being connected to the casing assembly 400 and extending at least partially into the stator accommodating cavity 422. That is, after the stator assembly 500 is connected to the casing assembly 400, the stator assembly 500 partially overlaps with the inner cylinder 420 in the radial direction to shorten the distance in the axial direction between the end of the stator assembly 500 away from the movable impeller 200 and the end of the casing assembly 400 away from the movable impeller 200, so as to reduce the axial dimensions of the whole electric fan and thus greatly reduce the size of the electric fan, thereby making it possible to achieve smaller size with the same motor power.

Referring to FIGS. 1, 2 and 7, the rotating shaft 610 mates with the stator assembly 500 and rotates at a high speed under the action of the stator assembly 500. The inner cylinder 420 is provided with a notch groove 423 at an end away from the fixed impeller 300, and it can be understood that the notch groove 423 is formed after a portion of the wall face is cut off at the end of the inner cylinder 420 away from the fixed impeller 300. The stator accommodating cavity 422 is in communication with the second diffuser channel 440 through the notch groove 423, so that the stator accommodating cavity 422, the notch groove 423, and the second diffuser channel 440 are in communication with each other to form a heat dissipation channel 424 of the electric motor.

When the electric motor is operating, heat is generated inside the rotating shaft 610 and the stator assembly 500 and the generated heat builds up. Since the stator accommodating cavity 422, the notch groove 423, and the second diffuser channel 440 are sequentially communicated to form the heat dissipation channel 424, the heat generated by the stator assembly 500 and the rotating shaft 610 can be dissipated through the heat dissipation channel 424. The heat is rapidly diffused by means of radiation dissipation and conduction dissipation so that the heat generated by the electric motor during its operation is taken away, thereby realizing rapid heat dissipation and cooling, and thus effectively reducing the temperature of the stator assembly 500 and the rotating shaft 610, which ensures the stability and safety of the electric fan when it is operating, and improves the service life of the electric motor.

It can be understood that the number of notch grooves 423 can be set to one, two, three or more than three, etc., depending on the actual needs. When the number of the notch grooves 423 is set to two, the notch grooves 423 may be arranged in a symmetrical manner, so that hot airflow flows out of the stator accommodating cavity 422 separately from the two notch grooves 423, thereby realizing uniform heat dissipation; and when the number of the notch grooves 423 is set to three or more, the notch grooves 423 may be distributed at equally spaced intervals at an end of the inner cylinder 420 away from the fixed impeller 300, which is conducive to uniform heat dissipation and better heat dissipation.

As the rotating shaft 610 drives the movable impeller 200 to rotate, the airflow flows along the air intake channel 110 and the first diffuser channel 310 in sequence. Referring to FIGS. 1 and 2, in some embodiments, the supporting base 320 is provided with a transition section 323, where the transition section 323 is located at an end of the supporting base 320 adjacent to the air intake end of the first diffuser channel 310, and the transition section 323 is used to guide the airflow to flow from the air intake channel 110 into the first diffuser channel 310 so that the airflow flows downstream from the air intake channel 110 to the first diffuser channel 310, thereby minimizing the loss of kinetic energy when the airflow enters the first diffuser channel 310 from the air intake channel 110, thus resulting in a higher wind output efficiency.

It can be understood that the transition section 323 may take the form of a cone, a disk, or a structure formed by combining a cone and a disk, meaning that the outer contour line of the transition section 323 may be of an inclined rectilinear shape or arc shape, or be formed by a number of inclined rectilinear lines and/or a number of arc lines connecting together. Referring to FIGS. 1-3, in some embodiments, the outer contour line of the transition section 323 is arc-shaped, i.e., the transition section 323 is of a dish-like structure, which can realize a smooth transition and have a better effect of flow guiding.

Further, the outer contour line of the transition section 323 has a first end and a second end, where the first end is higher in the axial direction than the second end; in other words, in the axial direction, the first end is closer to the movable impeller 200 compared to the second end. An angle between a straight line formed by connecting the two ends of the outer contour line of the transition section 323 and a horizontal line is 30°-65°, i.e., an angle between the line connecting the first end and the second end of the outer contour line of the transition section 323 forms an angle of 30°-65° with the horizontal line. When the airflow circulates from the movable impeller 200 to the fixed impeller 300, i.e., from the first diffuser channel 310 to the second diffuser channel 440, the airflow is converted from a state of high speed and low pressure to a state of low speed and high pressure. Setting the angle between the line connecting the first end and the second end of the outer contour line of the transition section 323 and the horizontal line to 30°-65° can provide a good transition effect, which ensures the diffusion effect and meets the diffusion requirement for airflow when the airflow enters into the second diffuser channel 440 from the first diffuser channel 310. The horizontal line is understood to be parallel to the radial direction of the inner cylinder 420 when the electric fan is placed in a state as shown in FIG. 1.

Further, along the axial direction of the movable impeller 200, the distance between an end of the outer contour line of the transition section 323 adjacent to the air outlet end of the air outlet channel and the maximum outer edge of the movable impeller body 210 is 0.5 mm-1 mm, which distance ensures that the airflow flows directly to the outer contour line of the transition section 323 after passing through the maximum outer edge of the movable impeller body 210, and then flows into the first diffuser channel 310 through the air outlet end of the air intake channel 110. Thus, a good transition effect can be achieved. Furthermore, leakage of part of the airflow into the gap formed between the supporting base 320 and the movable impeller 200 can be prevented when the distance is overly large; the leakage results in a loss of airflow and thus affects the wind output efficiency. At the same time, the inconvenience of mounting caused by the excessively small distance can be avoided. By setting this distance to 0.5 mm-1 mm, good mounting can be ensured, which facilitates mounting and can ensure the wind output efficiency of the electric fan.

After the airflow enters the first diffuser channel 310 for pressurization, it continues to enter the second diffuser channel 440 for secondary pressurization. In some embodiments, the number of the second diffuser blades 450 is greater than the number of the first diffuser blades 330, and the second diffuser blades 450 can separate the airflow flowing out from the first diffuser channel 310 into a plurality of portions, thereby reducing the pressure pulsation of the airflow, which is favorable for the stabilization of the airflow, and has a decelerating and pressurizing effect, and is favorable for the reduction of noise.

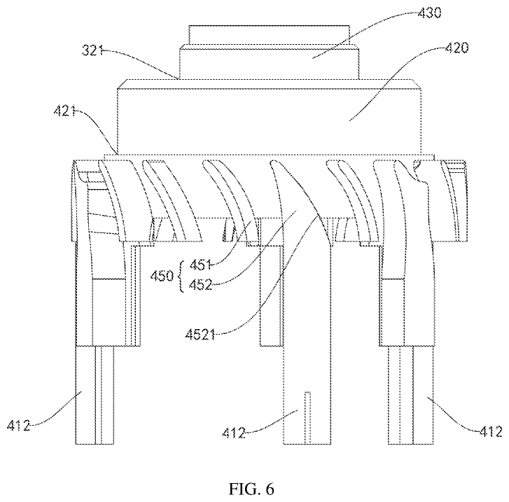

The shapes, thicknesses, and setting angles of the first diffuser blades 330 in the first diffuser channel 310 and the second diffuser blades 450 in the second diffuser channel 440 may be set according to the actual needs. Further, referring to FIG. 6, the second diffuser blade 450 includes a first blade structure 451 and a second blade structure 452, the second blade structure 452 including a main body portion and a thickened portion in sequence along the airflow direction of the second diffuser channel 440. The thickness of the thickened portion is greater than that of the main body portion, and the thickened portion is connected to the main body portion at a position of 0.5-0.8 times a chord length of the second blade structure 452.

An end of the second blade structure 452 away from the inner cylinder 420 is an outer edge, that is, an end of the second blade structure 452 adjacent to the outer cylinder 410 is an outer edge. The thickness of the outer edge of the main body portion gradually increases along the airflow direction at a position that is 0.1-0.3 times the chord length away from the second blade structure 452, and the thickness of the outer edge of the thickened portion is unchanged along the airflow direction.

In other words, the second blade structure 452 has an arc-shaped face 4521 raised along the circumferential direction, the arc-shaped face 4521 having a leading edge at an end adjacent to the air intake end of the second diffuser channel 440, and the arc-shaped face 4521 having a trailing edge at an end adjacent to the air outlet end of the second diffuser channel 440, with a line connecting the leading and trailing edges on the arc-shaped face 4521 forming the chord length. The thickness of the second blade structure 452 in the circumferential direction gradually increases from a position that is 0.1-0.3 times the chord length from the leading edge to a position that is 0.2-0.5 times the chord length from the trailing edge, and the thickness of the second blade structure 452 in the circumferential direction remains unchanged from a position that is 0.2-0.5 times the chord length from the trailing edge to the trailing edge position. The first blade structure 451 is provided between two adjacent second blade structures 452, and the thickness of the second blade structure 452 is kept unchanged after gradually increasing along the airflow direction, so that the flow area of the airflow is kept unchanged after gradually decreasing, thereby realizing a pressurization effect of the second diffuser blade 450 on the airflow. At the same time, since the second blade structure 452 provided in this manner can form a thick structure at the trailing edge, it is convenient to punch holes at the trailing edge of the second blade structure 452 for mounting the stator assembly 500, which ensures the diffusion effect of the airflow while realizing the mounting of the stator assembly 500.

Further, the minimum thickness of the outer edge of the second blade structure 452 is 0.1-0.3 times the maximum thickness of the outer edge of the second blade structure 452, i.e., the minimum thickness of the first blade structure 451 in the circumferential direction is 0.1-0.3 times the maximum thickness of the first blade structure 451 in the circumferential direction, which can realize the effect of stable pressurization. It should be noted that the maximum thickness of the outer edge of the second blade structure 452 should meet the requirements for punching holes. In addition, the minimum thickness of the outer edge of the second blade structure 452 may be set to about 0.4 mm-0.5 mm, which avoids the phenomenon of product defects due to the outer edge of the second blade structure 452 being too thin, thereby decreasing the defective rate of mold opening of the product.

Further, referring to FIGS. 1, 2, 6, and 7, the electric fan further includes an electric control board 700 and at least two first threaded fasteners, the electric control board 700 being connected to an end of the outer cylinder 410 away from the fan cover 100. Here, there are at least two supporting arms 412 of the outer cylinder 410 extending towards an end adjacent to the electric control board 700, the supporting arms 412 extending towards one side adjacent to the inner cylinder 420 and being connected to the second blade structure 452, i.e., to the thickened portion of the second blade structure 452. The supporting arm 412 is provided with first threaded holes 4121, the first threaded holes 4121 being arranged along the axial direction of the outer cylinder 410. The electric control board 700 is provided with at least two first communication holes 710, the first communication holes 710 being arranged along the axial direction of the outer cylinder 410, and the number and positions of the first communication holes 710 correspond to the number and positions of the first threaded holes 4121. The first threaded fasteners correspondingly extend through the communication holes and then extend into the first threaded holes 4121 to connect the electric control board 700 and the supporting arms 412, thereby realizing the fixing of the electric control board 700 to the casing assembly 400.

In some embodiments, the electric fan includes three first threaded fasteners, and the outer cylinder 410 has three supporting arms 412 extending toward an end adjacent to the electric control board 700; similarly, the electric control board 700 is provided with three first communication holes 710, and the outer cylinder 410 and the electric control board 700 are fixed after corresponding threading by the first threaded fasteners. For example, these three supporting arms 412 are distributed equally spaced apart at an end of the outer cylinder 410 adjacent to the electric control board 700, and these three first communication holes 710 are distributed equally spaced apart in the electric control board 700 and correspond one-to-one with the first threaded holes 4121 in the supporting arms 412. The casing assembly 400 and the electric control board 700 are connected and fixed through three positions, which allows for a stable triangular relationship to be formed, thus making the connection more robust.

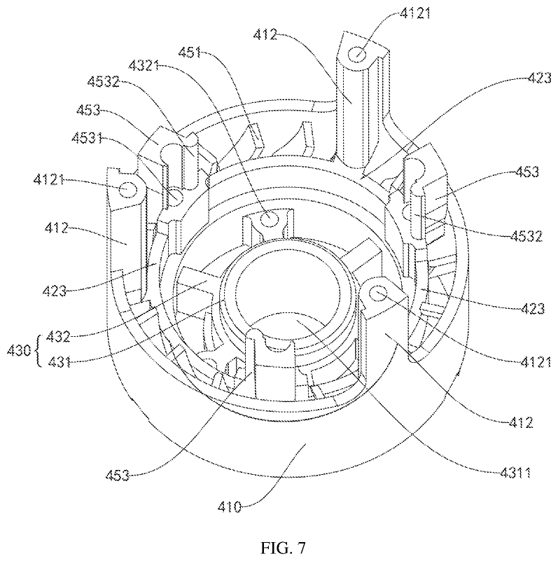

Further, referring to FIG. 7, the electric fan further includes at least two second threaded fasteners, the stator assembly 500 is provided with at least two locating slots and at least two second communication holes, and the second diffuser blade 450 are provided with at least two bosses 453 on a side adjacent to the electric control board 700, the bosses 453 being provided with second threaded holes 4531 and locating posts 4532. Among them, both the second communication holes and the second threaded holes 4531 are arranged along the axial direction of the outer cylinder 410. The locating posts 4532 are mated with the locating slots to be positioned in place. The second threaded fasteners correspondingly extend through the second communication holes and then extend into the second threaded holes 4531 to connect the stator assembly 500 and the bosses 453, thereby realizing the connection of the stator assembly 500 to the casing assembly 400.

In some embodiments, the electric fan includes three second threaded fasteners, the stator assembly 500 is provided with three locating slots and three second communication holes, and the second diffuser blades 450 are provided with three bosses 453 on a side adjacent to the electric control board 700. The casing assembly 400 and the stator assembly 500 are connected and fixed through three positions, which allows for a stable triangular relationship to be formed, thus making the connection more robust.

Further, the number of the second diffuser blade 450 is a multiple of 3 to facilitate the connection between the casing assembly 400 and the electric control board 700, and between the casing assembly 400 and the stator assembly 500, respectively, through three connection positions, thereby facilitating the mounting and fixing work.

The casing assembly 400 is connected to the fan cover 100 via an outer cylinder 410, and the fan cover 100 may be connected to the outer cylinder 410 by means of, for example, nesting, welding, or sealing mating, or the like. Further, referring to FIG. 1 and FIG. 2, the fan cover 100 is provided with a third sealing step 120 at an end adjacent to the outer cylinder 410, and the outer cylinder 410 is provided with a fourth sealing step 411 at an end adjacent to the fan cover 100, where the third sealing step 120 and the fourth sealing step 411 are sealingly mated, thereby improving the sealing of the apparatus and, at the same time, enabling rapid locating and mounting.

The electric fan in the embodiments of the present disclosure, by optimizing the internal structure, can greatly increase the power of the electric fan while satisfying the requirement for a small size, thereby ensuring that the maximum power density σ of the electric fan is not less than 0.0045 W/mm³, which satisfies the power requirement of the electric fan. Here, σ=P/(3.14*(D2/2)2*H), and it should be noted that H is the maximum distance between the fan cover 100 and the electric control board 700 in the axial direction, that is, in the axial direction, a distance between an end of the fan cover 100 away from the electric control board 700 and an end of the electric control board 700 away from the fan cover 100 is H. D2/2 is one-half of the outer diameter D2 of the outer cylinder 410. In addition, P is the maximum input power of the electric fan. Since the maximum input power P is a specification value of the electric fan, and the maximum input power P of the electric fan will be marked on the nameplate of the product, the explanation will not be expanded here.

Embodiments of the present disclosure also provide a cleaning apparatus. The cleaning apparatus includes an electric fan as described in the above embodiments, in which a movable impeller 200 is driven by an electric motor in the electric fan to rotate and to form airflow, which enters the first diffuser channel 310 through the air intake channel 110 to be pressurized and then flows out. During this period, the cleaning apparatus creates a negative pressure under the action of the electric fan and draws dust and other matter on the surface of the floor or other medium to be cleaned through the suction port of the cleaning apparatus in order to carry out the cleaning work. By defining the relationship among the outer diameter D2 of the outer cylinder 410, the maximum outer edge diameter D1 of the movable impeller body 210 and the outer diameter D3 of the supporting base 320, that is: D2=(1.2-1.6)D1, and D2=(1.15-1.6)D3, it is ensured that the electric fan can maximize the power while meeting the requirement of small size, so that an electric fan with an outer diameter of 45 mm or less can meet the power requirement of 450 W, thereby greatly increasing the upper limit of power that a small-sized electric fan can achieve, which facilitates the miniaturization and light-weight of the cleaning apparatus.

Although the embodiments of the present disclosure have been described in detail above with reference to the accompanying drawings, the present disclosure is not limited to the above embodiments, and various changes may be made within the knowledge of those of ordinary skill in the art without departing from the purpose of the present disclosure.

1. An electric fans comprising:
a fan cover;
a movable impeller arranged in the fan cover and forming an air intake channel with the fan cover, the movable impeller comprising a movable impeller body and air intake blades arranged on an outer periphery of the movable impeller body, with the movable impeller body having a maximum outer edge diameter of D1;
a casing assembly comprising an outer cylinder and a supporting structure arranged in the outer cylinder, wherein the outer cylinder is connected to the fan cover and the outer cylinder has an outer diameter of D2;
a fixed impeller connected to the supporting structure and located at an end of the supporting structure adjacent to the movable impeller, with a first diffuser channel being formed between the fixed impeller and the outer cylinder, wherein the first diffuser channel is in communication with the air intake channel, and the fixed impeller comprises a supporting base and first diffuser blades arranged on an outer periphery of the supporting base, with the supporting base having an outer diameter of D3; and
an electric motor for driving the movable impeller to rotate,
wherein D2=(1.2-1.6)D1, and D2=(1.15-1.6)D3.

2. The electric fan of claim 1, wherein:
the supporting structure comprises an inner cylinder and a mounting hub arranged in the inner cylinder;
a second diffuser channel is formed between the inner cylinder and the outer cylinder, the second diffuser channel being in communication with an air outlet end of the first diffuser channel; and
second diffuser blades are arranged between the inner cylinder and the outer cylinder, and the fixed impeller is mounted on the mounting hub.

3. The electric fan of claim 2, wherein:
the mounting hub comprises a bearing mounting base and a connecting structure;
the connecting structure is arranged between the bearing mounting base and the inner cylinder; and
the bearing mounting base comprises at least one first sealing step, the first sealing step being mated with an inner wall of the supporting base for seal.

4. The electric fan of claim 3, wherein:
the connecting structure comprises a plurality of connecting ribs distributed at intervals along a circumferential direction of the bearing mounting base; and
at least two of the connecting ribs comprise first connecting holes, and the supporting base comprises at least two second connecting holes, the first connecting holes and the second connecting holes being threaded and fixed by fasteners.

5. The electric fan of claim 3, wherein:
the supporting base comprises a first mating face extending along an axial direction and a second mating face extending along a radial direction at a sealing position mated with the first sealing step; and
the first sealing step has a first wall face and a second wall face that are connected to form an angle, the first wall face abutting against the first mating face, and the second wall face abutting against the second mating face, and the angle being greater than or equal to 90°.

6. The electric fan of claim 2, wherein:
a stator accommodating cavity is formed in the inner cylinder;
the electric motor comprises a stator assembly, the stator assembly being connected to the casing assembly and at least partially extending into the stator accommodating cavity; and
an end of the inner cylinder away from the fixed impeller comprises a notch groove, the notch groove being in communication with the stator accommodating cavity and the second diffuser channel.

7. The electric fan of claim 2, wherein the inner cylinder comprises a second sealing step, the second sealing step being mated with an inner peripheral wall of the supporting base for seal.

8. The electric fan of claim 1, wherein the supporting base comprises a transition section at an air intake end of the first diffuser channel, the transition section being configured to guide airflow to flow from the air intake channel to the first diffuser channel.

9. The electric fan of claim 8, wherein an outer contour line of the transition section is arc-shaped.

10. The electric fan of claim 9, wherein an angle between a straight line formed by connecting two ends of the outer contour line of the transition section and a horizontal line is 30°-65°.

11. The electric fan of claim 9, wherein along an axial direction of the movable impeller, a distance between an end of the outer contour line of the transition section adjacent to an air outlet end of the air outlet channel and a maximum outer edge of the movable impeller body is 0.5 mm-1 mm.

12. The electric fan of claim 2, wherein the number of the second diffuser blades is greater than the number of the first diffuser blades.

13. The electric fan of claim 2, wherein:
the second diffuser blade comprises a first blade structure and a second blade structure, the second blade structure comprising a main body portion and a thickened portion in sequence along an airflow direction of the second diffuser channel;
the thickened portion is connected to the main body portion at a position of 0.5-0.8 times a chord length of the second blade structure;
an end of the second blade structure away from the inner cylinder is an outer edge, with the thickness of the outer edge of the main body portion gradually increasing along the airflow direction at a position that is 0.1-0.3 times the chord length away from the second blade structure, and the thickness of the outer edge of the thickened portion being unchanged along the airflow direction; and
the first blade structure is arranged between adjacent second blade structures.

14. The electric fan of claim 13, wherein a minimum thickness of the outer edge of the second blade structure is 0.1-0.3 times a maximum thickness of the outer edge of the second blade structure.

15. The electric fan of claim 1, wherein an end of the casing assembly away from the fan cover comprises an electric control board, with a maximum distance between the fan cover and the electric control board in an axial direction being H, a maximum input power of the electric fan being P, and a maximum power density of the electric fan being σ, where σ=P/(3.14*(D2/2)²*H), and σ is greater than or equal to 0.0045 W/mm³.

16. A cleaning apparatus comprising an electric fan according to claim 1.
